(19) United States
(12) Patent Application Publication
(10) Pub. No.: US 2003/0083060 A1
(43) Pub. Date: May 1, 2003

(54) System for monitoring a service vehicle

(76) Inventor: Robert J. Menendez, Austin, TX (US)

Correspondence Address: CARDINAL LAW GROUP, SUITE 2000, 1603 ORRINGTON AVENUE, EVANSTON, IL, 60201, US

(21) Appl. No.: 10/040,288

(22) Filed: Oct. 25, 2001

(51) Int. Cl. H04Q 7/20

(52) U.S. Cl. 455/423; 455/456

(57) ABSTRACT

A service vehicle for making service calls at a plurality of locations comprises a position determination device, a subsystem indicator indicating a condition of a subsystem of the service vehicle, and an associated mobile communication device. A hub is in permanent communication with a central computer, and also communicates with the position determination device, the subsystem indicator, and the mobile communication device. A system for monitoring a service vehicle is also disclosed.

### TECHNICAL FIELD OF THE INVENTION

This invention relates generally to service vehicles, and more particularly to a system for monitoring a service vehicle.

### BACKGROUND OF THE INVENTION

Service and repair vehicles are a well-known sight. Many companies, particularly those with customers at numerous discrete locations, operate large fleets of service vehicles. In the case of providers of local telephone service, the technicians who normally operate these service vehicles may carry portable computers or other equipment to assist them. U.S. Pat. No. 5,764,726, for example, shows a telecommunications test system for a line to be tested including a test measurement device.

A variety of schemes exist to track the service calls made by the technicians. Cellular telephones and the Internet offer one way to enhance the efficiency of such schemes. However, dial-up Internet access affords only intermittent communications. Moreover telemetry about the service vehicle, which might be of interest to the company operating the fleet, has been transmitted independently from the substantive information about the service call, if it is transmitted at all.

### SUMMARY OF THE INVENTION

The present invention is a service vehicle for making service calls at a plurality of locations. The service vehicle comprises a position determination device, a subsystem indicator indicating a condition of a subsystem of the service vehicle, and an associated mobile communication device. A hub is in permanent communication with a central computer, and also communicates with the position determination device, the subsystem indicator, and the mobile communication device.

Accordingly, it is an object of the present invention to provide a service vehicle of the type described above which is in continuous communication with a central computer.

Another object of the present invention is to provide a service vehicle of the type described above in which some or all on-board devices communicate with a central computer through a single gateway.

These and other objects, features and advantages of the present invention are readily apparent from the following detailed description of the best mode for carrying out the invention when taken in conjunction with the accompanying drawings.

### BRIEF DESCRIPTION OF THE DRAWING

FIG. 1 is a schematic view of a system according to the present invention for monitoring a plurality of service vehicles.

### DETAILED DESCRIPTION OF THE PRESENTLY PREFERRED EMBODIMENTS

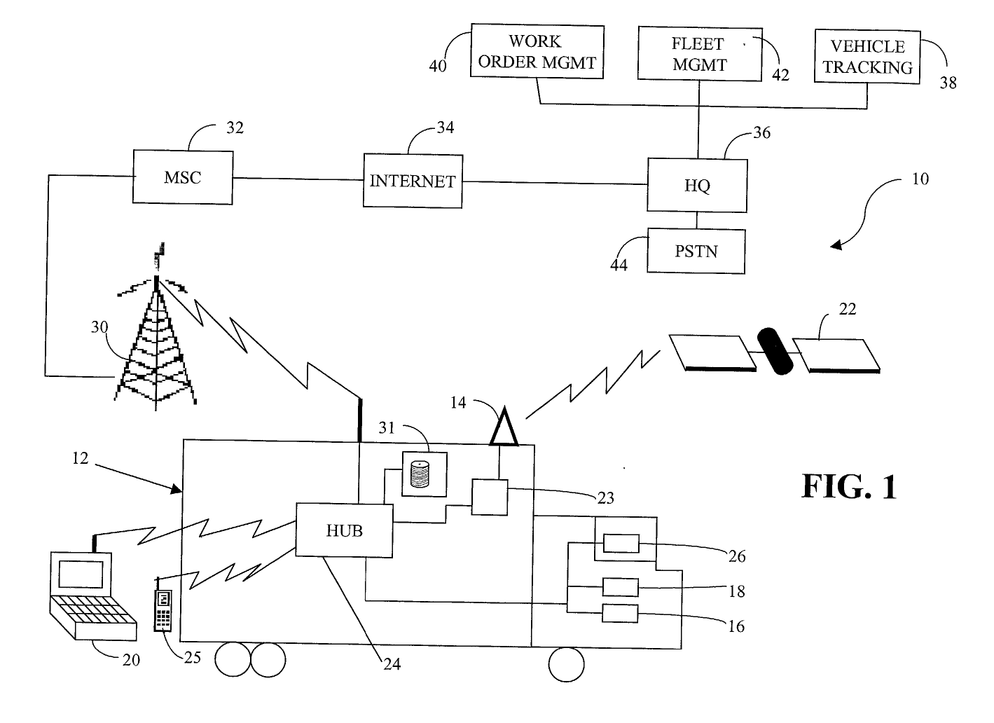

FIG. 1 shows a system 10 including a service vehicle 12 according to the present invention for making service calls at a plurality of locations. Each service vehicle 12 includes a position determination device 14, a location processing device 23, one or more subsystem indicators 16 and 18, a voice communication subsystem 25, a mobile communication device 20, an in-vehicle server 31, and a communications hub 24.

The position determination device 14 is preferably a global positioning system (GPS) receiver or antenna. As is well known, the GPS antenna receives signals from a series of satellites 22, and passes those signals to a GPS receiver that triangulates the position of the service vehicle 12 to a reasonable degree of accuracy. The location processing device 23 saves the position information from the GPS receiver to a storage device on the in-vehicle server 31 based on preprogrammed criteria which may include distance traveled from last stored position, time since last stored position, vehicle speed (as reported by the GPS receiver) and, in conjunction with ignition sensors, position of the vehicle when the ignition is switched from on to off and from off to on. Because the location processing device is programmable, other criteria are possible and more processing may occur with the position data.

The subsystem indicators 16 and 18 indicate a condition of a subsystem of the service vehicle 12. For instance, subsystem 16 may monitor data from the vehicle's on-board engine control module (ECM) or other sensors. Other potential data includes engine run time, odometer readings, oil pressure, engine RPM, water temperature, battery consumption and battery charge. This data is stored on a storage device in the server 31 when predetermined conditions are met. For example, data pertaining to oil pressure may be stored when its value drops below a given threshold, or data about water temperature may be stored when that value rises above a pre-programmed value. Engine run time, odometer reading, maximum engine RPM, and battery charge level (% of capacity) may be stored each time the ignition is switched from on to off.

Some service vehicles may have ancillary equipment such as power generators, air compressors or hydraulic lifts. For such vehicles, an indicator may monitor the condition of the ancillary equipment such as when the power generator or air compressor is switched from off to on and from on to off, and when the hydraulic lift is raised or lowered. Data to indicate the specific event may be stored in the subsystem's memory or on a storage device on the in-vehicle server 31.

The in-vehicle server 31 is provided as an auxiliary device with computing capacity and data storage. This storage may include non-volatile memory, a hard disk, and/or a compact disc drive for loading application or reference software. The reference materials may include information such as notes for diagnosing trouble conditions, maps of the locations of utility or telephone lines and related equipment, and street maps. Processing capability of the in-vehicle server 31 may be used to date and time stamp all stored data, to poll the remaining in-vehicle subsystems, to respond to requests for data from other in-vehicle subsystems or remote computers, to upload data from its storage to remote computers based on pre-programmed criteria, to download updated software to other subsystems, and to manage the communications between all the in-vehicle subsystems and the remote computers. It may also communicate with remote computers to update its databases, programs for itself, or programs for other subsystems.

The hub 24 may be hardwired to any combination of the remaining in-vehicle subsystems. In a preferred embodiment, the hub 24 is wired to these in-vehicle devices via a conventional 10 base T Ethernet connection. It should be appreciated, however, that the hub 24 might be in wireless communication with one or more of the subsystems 16, 18, 23, 26 and 31. Wireless communication schemes acceptable for these connections include any IEEE 802.11 protocol or what is commonly referred to as “Bluetooth.” In general, Bluetooth is a relatively low power system that affords short-range connections among disparate wireless devices equipped with a dedicated transceiver microchip or card that transmits and receives voice and data in a frequency band of about 2.45 GHz. Encryption and verification software are also preferably provided to facilitate secure communications.

The mobile communication device 20 may take the form of a portable computer, a tablet and keyboard, or a personal digital assistant (PDA). In the case where the service vehicle 12 is a telephone repair truck, the technician/vehicle operator normally carries the mobile communication device 20 to a location apart from the vehicle and more proximate to a source in need of service. Such locations may include indoor or outdoor telephones, lines and cables, cross connect equipment, or loop electronics. The mobile communication device is used to obtain work orders, report the status of work orders, display reference material, process messages and to initiate tests on equipment. In a preferred embodiment, the data for display on the mobile communication device may come from the in-vehicle server 31 or as a result of an interactive session with a remote computer. Because the mobile communication device 20 is portable, communications between it and the hub 24 are preferably wireless. A variety of wireless protocols are acceptable for communication between the hub and the mobile communication device. In a preferred embodiment, the hub 24 communicates with the mobile communication device 20 according to an IEEE 802.11 protocol, such as IEEE 802.11b. A docking and charging station 26 may be provided inside the service vehicle 12 for the mobile communication device 20.

The voice communication device 25 may resemble a conventional cellular telephone and may use a generally understood protocol such as Voice over IP (VoIP) or a cordless telephone technology. In a preferred embodiment, the voice communication device uses IEEE 802.11b to communicate through the hub 24 to a VoIP gateway. The VoIP gateway transforms the VoIP protocol to traditional voice traffic and transmits the voice traffic over a traditional voice network, either wireless or a land based voice network such as a publicly switched telephone network (PSTN) 44. The VoIP gateway may be another subsystem within the vehicle, inside the hub or at a computer within the wireless communication provider's network, the Internet or in the Corporate Intranet. In the case where the VoIP gateway is in another in-vehicle subsystem or inside the hub and the wireless communication service has simultaneous voice and data capability, the transformation of VoIP to traditional voice can use the wireless link to a wireless communications provider. Where a data only upstream wireless network is used, the VoIP gateway must necessarily be outside the vehicle. If a virtual private network (VPN) is used, the VoIP gateway must be on or accessible to the Corporate Intranet. The voice communication device preferably has a small display screen and includes the ability to receive and/or transmit small text messages. Text messages for this device are traditional pager messages or messages resulting from use of Short Message Service at a wireless communication provider. The docking station 26 may provide the voice communication device 25 with an auxiliary microphone and speaker for hands-free operation, as well as battery recharging.

The system 10 efficiently manages service work, and manages service vehicles as corporate assets. To satisfy this need, a series of corporate computers are attached to the Corporate Intranet, and the communication hub 24 maintains two-way communications with the computers through the Corporate Intranet. This upstream connection is established and maintained through wireless communication with a wireless telephone network as represented by tower 30. The hub 24 may communicate with the wireless telephone tower 30 through any known standard, but desirably communicates at least in part according to Global System for Mobile Communication (GSM)/General Packet Radio Services (GPRS), or any protocol that has the capability to handle simultaneous voice and data. GPRS are packet-based services that use communication channels on a shared-use, as-packets-are-needed basis rather than dedicated only to one user at a time. GPRS data transfer rates generally range from about 56 to about 114 Kbps. Cellular digital packet data (CDPD) may also be used if a “data only” configuration will suffice. Code Division Multiple Access networks (e.g., CDMA2000 1X) may also be used if alternate (not simultaneous) voice and data will suffice.

The wireless telephone tower 30 in turn communicates through land lines with a mobile switching center (MSC) 32. Computers within the mobile switching center or elsewhere within the wireless communication carrier's network provide gateway services to the Internet, information services, commercial ISPs or access to Corporate Intranets 34. In order to preserve security for potentially sensitive or proprietary information, connections to Corporate Intranets preferably use VPN technology. In the preferred embodiment, communications between the hub 24 and the Corporate Intranet 36 use VPN technology.

The hub 24 is capable of managing connections to a Corporate Intranet and a VPN connection on behalf of the in-vehicle sub systems. This includes all necessary security and authentication required to set up the required sessions. On occasion, the upstream link may be lost. The communication hub may also drop the upstream communication link after a period of inactivity. The vehicle subsystems (typically the in-vehicle server 31 or mobile communication device 20) will send requests to the hub before starting communications. If the upstream communication is not active, the hub will attempt to reestablish the link. If the link cannot be reestablished, a message will be returned indicating that service is not available. The hub will try to reestablish the link after a preprogrammed interval. When the link has been reestablished, all subsystems that previously requested service will be so notified. The in-vehicle subsystems are thereby aware of the connection status and may hold data in their memories until the communication link has been restored.

A plurality of computers on the Corporate Intranet are used to perform various functions. The following provides some examples of corporate computing systems which, in conjunction with data provided by or sent to the in-vehicle systems, manage service work and vehicles as corporate assets.

A Work Order Management system 40 is used to dispatch vehicles and technicians to locations where service is required. This is normally the primary system used by the field technician. The work order management system gets work orders (new orders, repair orders, etc.) from other corporate systems. The system uses a plurality of criteria for determining which technician to dispatch on specific work orders. These criteria include, but are not limited to, skills matching between the work order and technician, time commitments to customers, and drive from the current location to the work order site. Determination of drive time from current location to the work order site can be significantly enhanced if the work order system can obtain the current location from the in-vehicle location processing device.

Service histories are maintained and correlated with other service histories by computing systems inside the Corporate Intranet. Some telephone line tests may be initiated by sending a message from the mobile communication device 20 to a corporate computer, and then to auxiliary equipment within the telephone network. Other tests are performed with equipment that may be a part of the mobile computing device 20. In either case, test results are gathered at the corporate computer or database so designated.

Vehicle travel histories are used to manage the efficiency of the dispatch system and field service organization. Location data obtained from the in-vehicle location processing device 23 is collected in a corporate Vehicle Tracking system 38. Various reports are prepared from this data to manage the field service organization. Some examples include excess idle time at the beginning of a work day, excess idle time spent at the end of a work day, and unscheduled stops. This data is also useful in investigating accident reports or customer complaints.

A Fleet Management system 42 is used by the corporate organization responsible for managing the vehicle fleet and maintaining the vehicles. The system 42 gathers, stores and processes data retrieved from the vehicle telemetry systems. This data helps keep the vehicles in optimal running order, and analysis of the data may pinpoint potential problems before they cause vehicle breakdowns in remote locations.

Other information such as driving directions, weather conditions and traffic conditions may also be provided from systems on or accessible to the Corporate Intranet.

While specific embodiments of the present invention have been shown and described, it will be apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are intended to be embraced therein.

What is claimed is:

1. A service vehicle for making service calls at a plurality of locations, the service vehicle comprising:
a position determination device;
a subsystem indicator indicating a condition of a subsystem of the service vehicle;
an associated mobile communication device; and
a hub in permanent communication with a central computer, the hub communicating with the position determination device, the subsystem indicator, and the mobile communication device.

2. The service vehicle of claim 1 wherein the position determination device comprises a global positioning system receiver.

3. The service vehicle of claim 1 wherein the subsystem indicator indicates the condition of an ignition of the service vehicle.

4. The service vehicle of claim 1 wherein the subsystem indicator indicates the condition of an odometer of the service vehicle.

5. The service vehicle of claim 1 wherein the hub is in wireless communication with a cellular telephone tower.

6. The service vehicle of claim 1 wherein the central computer communicates with an Internet site.

7. The service vehicle of claim 1 wherein the central computer comprises a private network.

8. The service vehicle of claim 1 wherein the hub communicates with the central computer at least in part according to CDPD protocol.

9. The service vehicle of claim 1 wherein the hub communicates with the central computer at least in part according to GPRS protocol.

10. The service vehicle of claim 1 wherein the central computer provides directions to the service vehicle to a subsequent destination.

11. The service vehicle of claim 1 wherein the central computer provides traffic data to the service vehicle.

12. The service vehicle of claim 1 wherein the hub is in wireless communication with the mobile communication device.

13. The service vehicle of claim 1 wherein the hub is in wireless communication with the mobile communication device according to an IEEE 802.11 protocol.

14. The service vehicle of claim 1 wherein the hub is in wireless communication with the mobile communication device according to a bluetooth protocol.

15. The service vehicle of claim 1 wherein the hub is in wireless communication with the subsystem indicator.

16. A system for monitoring a plurality of service vehicles, the system comprising:
a central computer;
a position determination device in each service vehicle;
a subsystem indicator in each service vehicle, the subsystem indicator indicating a condition of a subsystem of the service vehicle;
a mobile communication device associated with each service vehicle; and
a hub in each service vehicle, the hub being in permanent communication with the central computer, the hub communicating with the position determination device, the subsystem indicator, and the mobile communication device.

17. The system of claim 16 wherein the position determination device comprises a global positioning system receiver.

18. The system of claim 16 wherein the subsystem indicator indicates the condition of an ignition of the service vehicle.

19. The system of claim 16 wherein the subsystem indicator indicates the condition of an odometer of the service vehicle.

20. The system of claim 16 wherein the hub is in wireless communication with a cellular telephone tower.

21. The system of claim 16 wherein the central computer communicates with an Internet site.

22. The system of claim 16 wherein the central computer comprises a private network.

23. The system of claim 16 wherein the hub communicates with the central computer at least in part according to CDPD protocol.

24. The system of claim 16 wherein the hub communicates with the central computer at least in part according to GPRS protocol.

25. The system of claim 16 wherein the central computer provides directions to the service vehicle to a subsequent destination.

26. The system of claim 16 wherein the central computer provides traffic data to the service vehicle.

27. The system of claim 16 wherein the hub is in wireless communication with the mobile communication device.

28. The system of claim 16 wherein the hub is in wireless communication with the mobile communication device according to an IEEE 802.11 protocol.

29. The system of claim 16 wherein the hub is in wireless communication with the mobile communication device according to a bluetooth protocol

30. The system of claim 16 wherein the hub is in wireless communication with the subsystem indicator.

31. A method of coordinating a plurality of service vehicles, comprising:
providing a central computer;
providing each service vehicle with a position determination device, a subsystem indicator, a mobile communication device, and a hub in permanent communication with the central computer, the hub communicating with the position determination device, the subsystem indicator, and the mobile communication device; and
directing the service vehicle to a subsequent service call based on the information received by the central computer from the hub.
